(19) United States
(12) Patent Application Publication
(10) Pub. No.: US 2012/0030308 A1
(43) Pub. Date: Feb. 2, 2012

(54) LOCATING ENTITIES

(76) Inventors: Peter Jeffe, Austin, TX (US); Sandeep Mathur, Austin, TX (US)

(21) Appl. No.: 12/901,266

(22) Filed: Oct. 8, 2010

Related U.S. Application Data
(60) Provisional application No. 61/249,739, filed on Oct. 8, 2009.

(51) Int. Cl. G06F 15/16

(52) U.S. Cl. 709/217

(57) ABSTRACT

In some embodiments, a method of transmitting information between two or more entities in a network includes a computer system in the network receiving one or more selection criteria from a first entity in the network. The method further includes the computer system determining one or more other entities in the network associated with the received selection criteria. The method still further includes the computer system communicating information at least partially describing the determined entities to the first entity. The method still further includes the computer system receiving an entity selection from the first entity. The method still further includes the computer system communicatively coupling the first entity to a selected entity of the determined entities such that interaction between the first entity and information regarding the selected entity is permitted.

### PRIORITY CLAIM

This patent application claims priority to U.S. Provisional Patent No. 61/249,739 entitled “LOCATING ENTITIES” to Jeffe et al. filed on Oct. 8, 2009, which is incorporated by reference in its entirety.

### BACKGROUND OF THE INVENTION

1. Field of the Invention

This disclosure relates generally to the field of locating an entity and, more specifically, this disclosure pertains to the field of locating an entity where locating the entity includes selecting multiple entities based on one or more selection criteria.

2. Description of the Relevant Art

Location based services have been used to present information to a user at a determined location. In one example, advertising information has been presented to a user of a mobile device (e.g., a PDA, laptop, smartphone, etc.) based on a determined location of the mobile device. In another example, the mobile device may be used to locate places of interest, such as gas stations, hospitals, restaurants, shopping centers, grocery stores, etc. within a vicinity of a location of the mobile device.

### SUMMARY OF THE INVENTION

In some embodiments, a method of transmitting information between two or more entities in a network includes a computer system in the network receiving one or more selection criteria from a first entity in the network. The method further includes the computer system determining one or more other entities in the network associated with the received selection criteria. The method still further includes the computer system communicating information at least partially describing the determined entities to the first entity. The method still further includes the computer system receiving an entity selection from the first entity. The method still further includes the computer system communicatively coupling the first entity to a selected entity of the determined entities such that interaction between the first entity and information regarding the selected entity is permitted.

To facilitate transfer of information between the entities, the computer system may couple the entity to a selected other entity to allow interaction of the entity with the information of the other entity. The coupling may be direct, where the entity may directly access the information on the other entities' computing systems. In other embodiment, information from the other entities' computer systems may be virtually present to the requesting entity by the computer system.

In some embodiments, a computer system includes a processor and a memory coupled to the processor and configured to store program instructions executable by the process or to implement a method of transmitting information between two or more entities in a network.

In some embodiments, a tangible, computer readable physical storage medium includes program instructions stored thereon. The program instructions are computer executable to implement a method of transmitting information between two or more entities in a network.

### BRIEF DESCRIPTION OF THE DRAWINGS

The embodiments of the disclosure will become apparent upon reading the following detailed description and upon reference to the accompanying drawings in which:

FIG. 1 is a block diagram of one or more network communications systems, according to one or more embodiments;

FIG. 2 is a block diagram of one or more network communications systems, according to one or more embodiments;

FIG. 3 is a block diagram of a computing device, according to one or more embodiments;

FIG. 4 is a block diagram of a server computing device, according to one or more embodiments;

FIG. 5 is method for determining one or more entities associated with one or more selection criteria, according to one or more embodiments;

FIG. 6 is an exemplary menu, according to one or more embodiments;

FIG. 7 is an exemplary map indicating one or more entities and groups of entities, according to one or more embodiments;

FIG. 8 is an exemplary map indicating one or more entities, according to one or more embodiments;

FIG. 9 is an exemplary map and an exemplary menu, according to one or more embodiments;

FIG. 10 is an exemplary input menu, according to one or more embodiments;

FIG. 11A is a method for exploring an entity associated with one or more selection criteria, according to one or more embodiments;

FIG. 11B is a method for exploring an entity associated with one or more selection criteria, according to one or more embodiments;

FIG. 12 is an exemplary diagram of information associated with an entity selection, according to one or more embodiments;

FIG. 13 is an exemplary library of an entity, according to one or more embodiments;

FIG. 14 is an exemplary menu associated with a library element, according to one or more embodiments;

FIG. 15 is an exemplary media player interface associated with a library element, according to one or more embodiments;

FIG. 16 is an exemplary diagram of information associated with an entity selection, according to one or more embodiments; and

FIG. 17 is an exemplary map indicating one or more entities, according to one or more embodiments.

While the embodiments described herein are susceptible to one or more modifications and/or one or more alternative forms, specific embodiments thereof are shown by way of example in the drawings and will herein be described in detail. It should be understood, however, that the drawings and detailed description thereto are not intended to limit the disclosure to the particular form disclosed, but on the contrary, the disclosure is to cover all modifications, equivalents and/or alternatives.

### DETAILED DESCRIPTION OF THE PREFERRED EMBODIMENTS

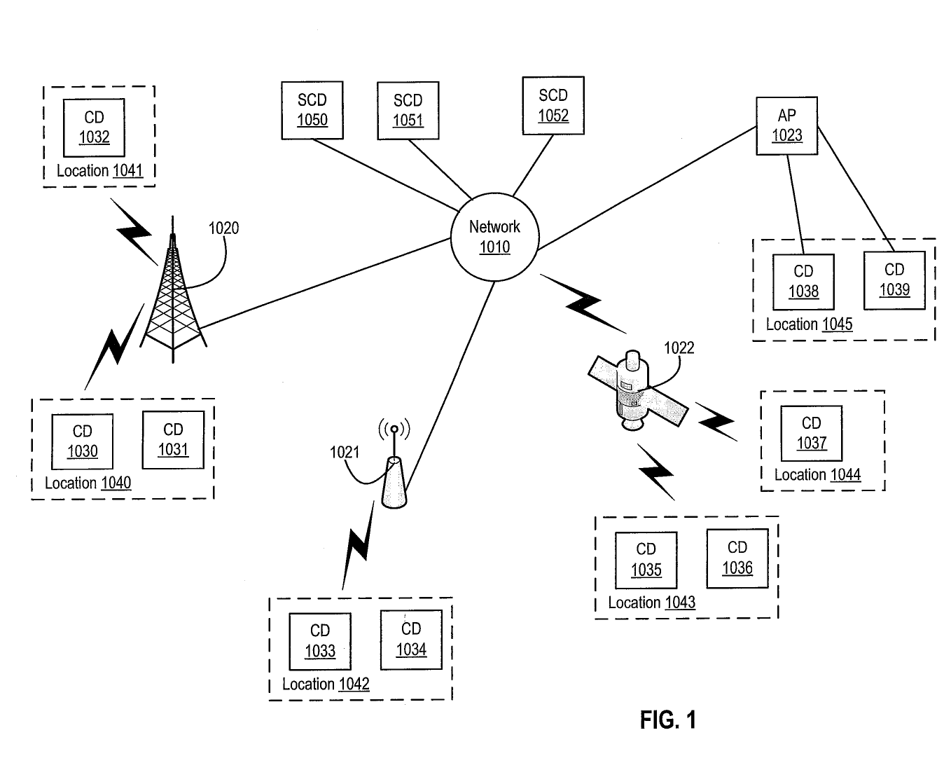

FIG. 1 is a block diagram of one or more network communications systems in accordance with one or more embodiments. In some embodiments, a network 1010 may be coupled to one or more access points (APs) 1020-1023. Each access point (AP) of APs 1020-1023 may be coupled to one or more respective computing devices (CDs) of CDs 1030-1039. In some embodiments, CDs 1030-1039 may be coupled to network 1010 through respective APs 1020-1023. In some embodiments, an AP, such as one of APs 1020-1023, may be coupled to network 1010 in a wireless and/or wired fashion.

In some embodiments, network 1010 may include and/or be coupled to various communications networks. Examples of a communications networks include, but are not limited to a wide area network (WAN), a public network such as an Internet, a public switched telephone network (PSTN), and/or a local area network (LAN), etc. One or more of APs 1020-1023 may be coupled to one or more various networks. For example, in some embodiments, one or more of a WAN, a public network such as an Internet, a PSTN, and LAN may include one or more wired networks and/or one or more wireless networks.

In some embodiments, CDs 1030-1032 may be coupled to AP 1020 in a wireless fashion. In some embodiments, AP 1020 may include a support for cellular telephone services. In certain embodiments, AP 1020 may communicate with CDs 1030-1032 using one or more suitable cellular telephone protocols. Examples of suitable cellular telephone protocols include, but are not limited to, CDMA (code division multiple access), General Packet Radio Service (GPRS), FDMA (frequency division multiple access), and TDMA (time division multiple access), etc. In some embodiments, AP 1020 may include support for a metropolitan area network (MAN). For example, AP 1020 may communicate with CDs 1030-1032 using one or more suitable MAN protocols. Examples of suitable MAN protocols include, but are not limited to, WiMAX and IEEE (Institute of Electrical and Electronics Engineers) 802.16. In some embodiments, AP 1020 may communicate with CDs 1030-1032 using a Long Term Evolution (LTE) protocol. In some embodiments, CDs 1030 and 1031 may be at a location 1040, and computing device (CD) 1032 may be at a location 1041.

In some embodiments, CDs 1033 and 1034 may be coupled to AP 1021 in a wireless fashion. In some embodiments, AP 1021 may include a wireless access point providing one or more of a wireless LAN and/or a wireless personal are network (PAN) services during use. For example, during use, AP 1021 may communicate with CDs 1033 and 1034 using one or more of wireless Ethernet (IEEE 802.11), Bluetooth (IEEE 802.15), IEEE 802.15.4, ultra wide band, and infrared communication technologies, etc. In some embodiments, CDs 1033 and 1034 may be at a location 1042.

In some embodiments, CDs 1035-1037 may be coupled to AP 1022 in a wireless fashion. In some embodiments, AP 1022 may include a satellite that communicating with CDs 1035-1037 using one or more satellite telephone protocols and/or one more satellite data transfer protocols during use. In some embodiments, CDs 1035 and 1036 may be at a location 1043, and CD 1037 may be at a location 1044.

In some embodiments, CDs 1038 and 1039 may be coupled to AP 1023 in a wired fashion. In some embodiments, AP 1023 may include one or more of an Ethernet port, a router, a DSL (digital subscriber loop) modem, a cable modem, a demarcation for a PSTN, and an Ethernet switch, etc. In some embodiments, CDs 1038 and 1039 may be at a location 1045.

In some embodiments, one or more server computing devices (SCDs) such as SCDs 1050-1052 may be coupled to network 1010. In some embodiments, one or more of SCDs 1050-1052 may communicate with one or more of CDs 1030-1039 through network 1010.

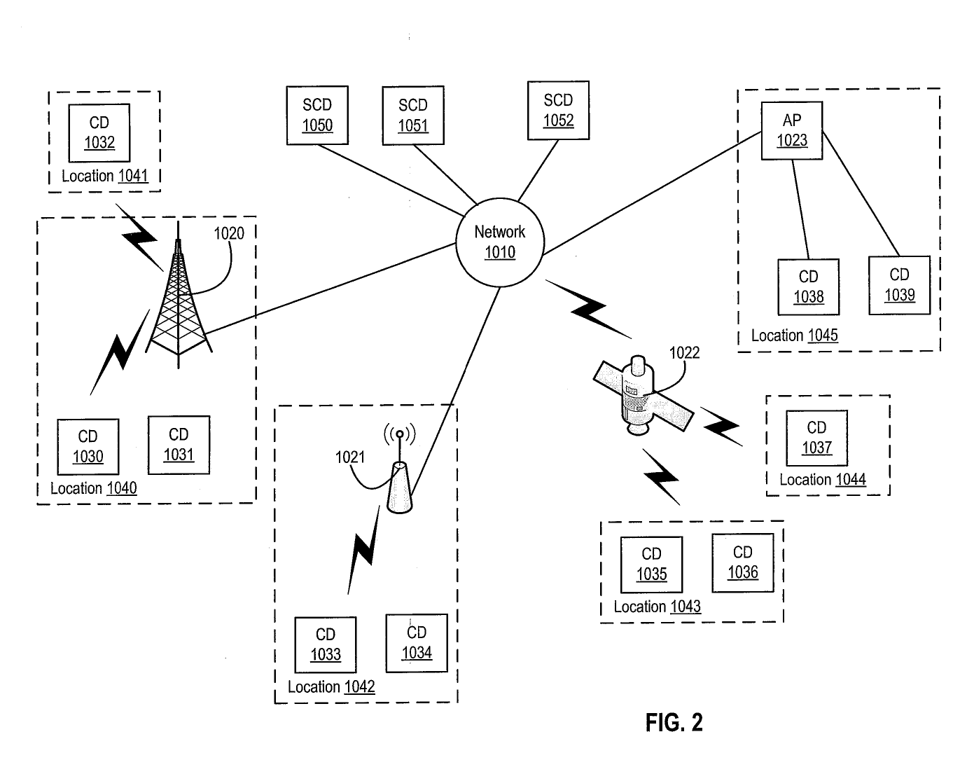

FIG. 2 is a block diagram of one or more network communications systems in accordance with one or more embodiments. Elements illustrated in FIG. 2 are described with reference to FIG. 1. In some embodiments, one or more of APs 1020-1023 may be located at various locations. For example, location 1040 may include AP 1020, location 1042 may include AP 1021, and location 1045 may include AP 1023. In some embodiments, locations of one or more APs may be stored in a database. In some embodiments, it may be determined which AP is communicating with a CD. In certain embodiments, the database may be used to determine a location of the AP; the location may then be used to determine the location of the CD communicating with the AP. For example, it may be determined that AP 1021 is communicating with CD 1034. The database may then be used to determine a location of AP 1021 (e.g., location 1042) which may be used to determine the location of CD 1034 communicating with AP 1021. For instance, the location of CD 1034 may be the location of AP 1021 which is location 1042.

In some embodiments, locations 1040-1045 may vary in size. In one example, location 1040 may include a geographic area of some number of thousand feet to some number of miles within a vicinity of AP 1020. In a second example, location 1042 may include a geographic area of some number of tens to hundred(s) of feet within a vicinity of AP 1021. In yet another example, location 1045 may include a geographic area of an abode, a retail establishment, a bar, a hotel, a dance hall, a pool hall, etc.

In some embodiments, a CD may provide its location. In some embodiments, each of one or more of CDs 1030-1039 may determine its location and provide its location to another computing device or computer system, such as one of CDs 1030-1039 and/or SCDs 1050-1052. For example, one or more of CDs 1030-1039 may include a global positioning system (GPS) that may be used to determine a location. In one example, CD 1032 may include a GPS and communicate location 1041 to one or more of CDs 1030, 1032-1039 and/or SCDs 1050-1052. In another example, CD 1035 may include a GPS and communicate location 1043 to one or more of CDs 1030-1034, 1036-1039 and/or SCDs 1050-1052.

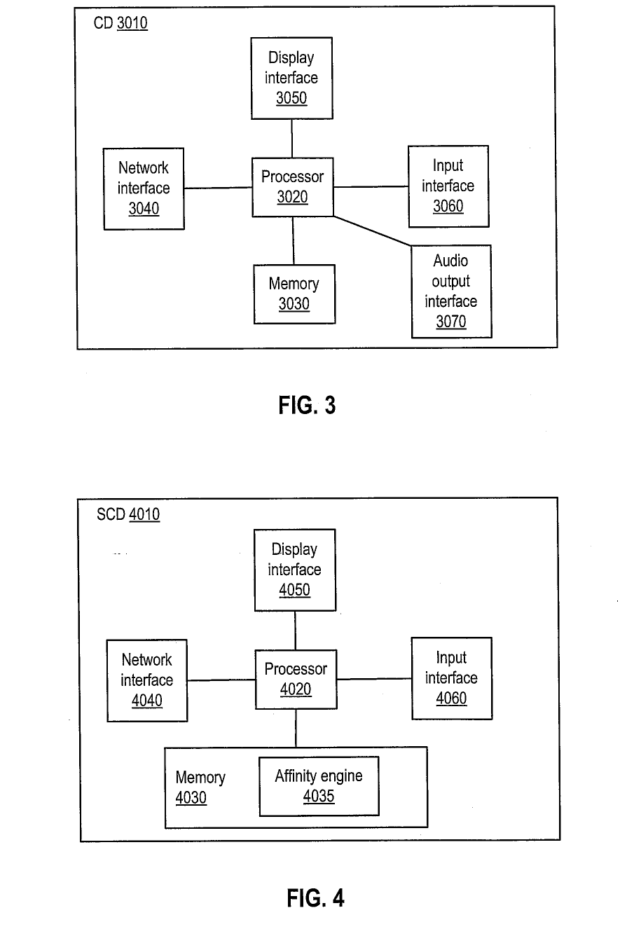

FIG. 3 is a block diagram of a computing device in accordance with one or more embodiments. In some embodiments, a CD 3010 may include a processor 3020 that may be coupled to a memory 3030. In some embodiments, processor 3020 may retrieve and execute instructions from memory 3030 to implement one or more methods and/or processes described herein. In some embodiments, CD 3010 may include a network interface 3040, a display interface 3050, an input interface 3060, and an audio output interface 3070 coupled to processor 3020. In some embodiments, network interface may include logic, circuitry, and/or a transceiver configured to interface and communicate with one or more of APs 1020-1023.

In some embodiments, display interface 3050 may interface with a display configured to convey information to a user of CD 3010. In some embodiments, the display may be included in CD 3010. In certain embodiments, the display may be external to CD 3010. In some embodiments, input interface 3060 may receive user input from a user of CD 3010. In some embodiments, input interface 3060 may interface with a keyboard. In certain embodiments, input interface 3060 may interface with a pointing device (e.g., a mouse, track pad, etc.). In certain embodiments, input interface 3060 may interface with a microphone (e.g., to receive voice input commands). In still further embodiments, input interface 3060 may interface with a touch screen (e.g., resistive sense, capacitive sense, etc.). In some embodiments, one or more of the keyboard, the pointing device, the microphone, and the touch interface may be included in CD 3010 or may be external to CD 3010.

In some embodiments, audio output interface 3070 may convey audio signals and/or data to an audio output device. In some embodiments, the audio output device may include logic and/or circuitry facilitating outputting sound signals during use. For example, the logic and/or circuitry may include one or more digital-to-analog converters. In some embodiments, the audio output device may include a speaker.

In some embodiments, CD 3010 may take various forms, including a mobile telephone, a personal digital assistant (PDA), a laptop, a notebook, a netbook, a network appliance, an Internet appliance, a wearable computing device, a mobile multimedia device, an embedded computer system, a television system, a workstation, a personal computer system (e.g., a desktop computer system), and/or other device.

In some embodiments, terms such as “computing device”, “computer”, and/or “computer system” may be broadly defined to encompass any device including a processor that executes instructions from a memory. In some embodiments, one or more of CDs 1030-1039 may include one or more elements and/or one or more functionalities described with reference to CD 3010.

FIG. 4 is a block diagram of a server computing device in accordance with one or more embodiments. In some embodiments, a SCD 4010 may include a processor 4020 that may be coupled to a memory 4030. In some embodiments, processor 4020 may retrieve and execute instructions from memory 4030 to implement one or more methods and/or processes described herein. In some embodiments, SCD 4010 may include a network interface 4040, a display interface 4050, and an input interface 4060 coupled to processor 4020. In some embodiments, network interface may include logic, circuitry, and/or a transceiver configured to interface and communicate with network 1010. In some embodiments, display interface 4050 may interface with a display configured to convey information to a user of SCD 4010. For example, the display may be included in SCD 4010 or be external to SCD 4010. In some embodiments, input interface 4060 may receive user input from a user of SCD 4010. For example, the user may be at a console interface of SCD 4010. In some embodiments, input interface 3060 may interface with a keyboard. In some embodiments, input interface 3060 may interface with a pointing device (e.g., a mouse, track pad, etc.). In some embodiments, one or more of SCDs 1050-1052 may include one or more elements and/or one or more functionalities described with reference to SCD 4010.

In some embodiments, memory 4030 may include an affinity engine 4035 that may include instructions executable by processor 4020 to implement an affinity engine. In some embodiments, an affinity engine (which may also be referred to as a recommendation engine or a recommendation system) may be used to determine one or more recommendations of one or more entities associated with one or more selection criteria. For example, the affinity engine may use input of a user and/or a music library of the user to generate one or more recommendations of one or more entities that have similar musical tastes and/or other similarities. In some embodiments, each song (e.g., played, playing, in a library, etc.) may be associated with one or more quantifiable attributes. In some embodiments, the one or more attributes may include one or more genres. For example, the one or more genres may include one or more of country, rock, classical, swing, big band, 80s, 70s, 60s, hip hop, rap, top 40, and pop, among others. In some embodiments, the one or more attributes may include one or more numbers that indicate how many times specific songs are played. In some embodiments, the one or more attributes may include one or more preferences for one or more of musicians, genres, song ratings, musician ratings, genre ratings, and user specified preferences (e.g., specifying a favorite musician, a favorite song, a top-10 favorite musicians, a top-10 favorite songs, etc.), and a grouping of songs (e.g., a playlist), etc. In still further embodiments, the one or more attributes may include one or more dislikes. For example, the one or more dislikes may include one or more genres, musicians, and songs, among others. In some embodiments, the affinity engine may use multiple songs played over a period of time by a computing device to generate one or more recommendations. For example, CD 1038 may include a jukebox at a place (e.g., a public place, a private place, a bar, a pool hall, a dance hall, a park, a community center, a monument, a yacht club, a country club, a fitness club, an establishment, etc.), and the affinity engine may use multiple songs played over a period of time by CD 1038 to generate one or more recommendations to entities (e.g., users, etc.).

In some embodiments, terms such as “memory medium” and/or “computer readable medium” may include one or more types of memory or storage, a random access memory or computer system memory (e.g., DRAM, SRAM, and/or RAM, etc.), a non-volatile memory such as NVRAM, EPROM, EEPROM, flash memory, a magnetic media (e.g., a hard drive, and/or optical storage), an installation medium (e.g., a CD-ROM, DVD-ROM, or floppy disks, etc.). In some embodiments, a memory medium may include other types of memory as well, or combinations thereof. In some embodiments, a memory medium may be and/or include an article of manufacture and/or a software product. For example, a memory medium may store instructions executable by a processor or computer system.

In some embodiments, a memory medium may be located in a first computer in which the instructions are executed. In some embodiments, a memory medium may be located in a second computer and/or hardware memory device that connects to a first computer over a network. For example, during use, the second computer may provide program instructions to the first computer for execution by the first computer.

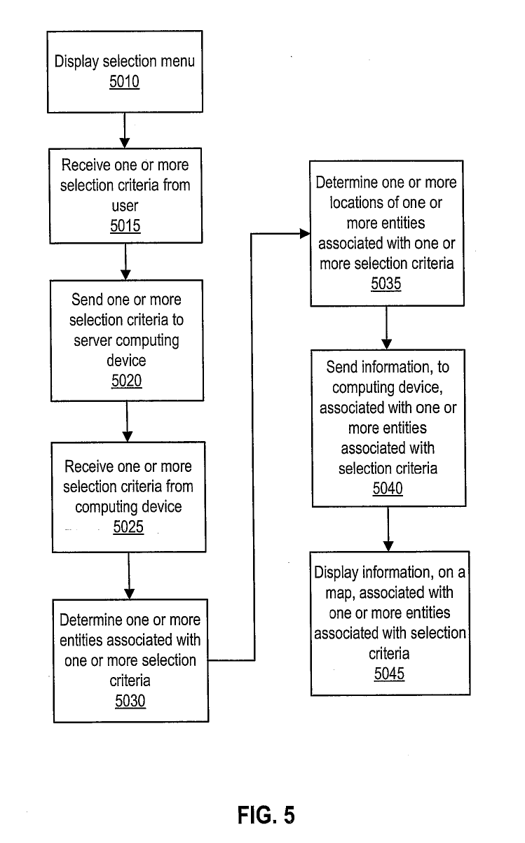

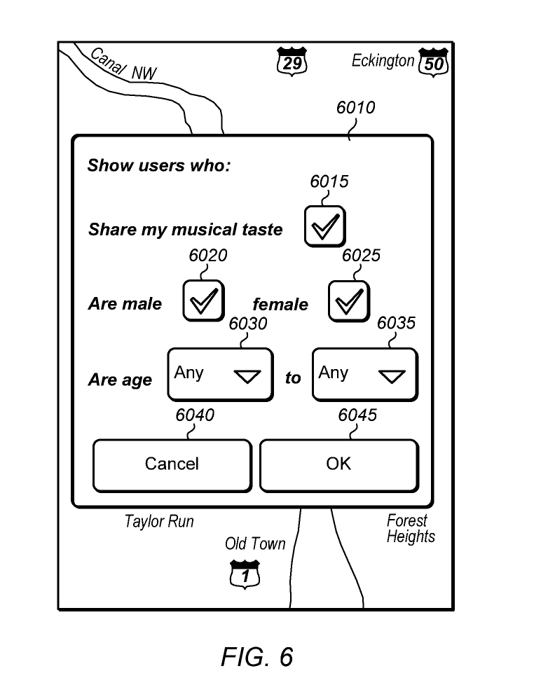

FIG. 5 is a flow chart illustrating a method for determining one or more entities associated with one or more selection criteria in accordance with one or more embodiments. At 5010, a selection menu may be displayed. In some embodiments, a selection menu may be displayed to a user of CD 1030. For example, a selection menu 6010 (see FIG. 6) may be displayed to a user of CD 1030. At 5015, one or more selection criteria may be received from a user. For example, the one or more selection criteria may be received from a user of CD 1030. In some embodiments, an application executing on CD 1030 may receive the one or more selection criteria from the user. For example, the application may include a custom application configured to receive the one or more selection criteria from the user. In another example, the application may include a web browser configured to receive the one or more selection criteria from the user.

At 5020, the one or more selection criteria may be sent to a server. For example, CD 1030 may send the one or more selection criteria to SCD 1050. In some embodiments, SCD 1050 may include an affinity engine, and the one or more selection criteria may be communicated to the affinity engine to determine one or more entities associated with the one or more selection criteria. In some embodiments, SCD 1050 may interface and communicate (e.g., over a network such as network 1010) with another computer system (e.g., SCD 1051) that includes an affinity engine. For example, SCD 1050 may send the one or more selection criteria to SCD 1051, and the one or more selection criteria may be communicated to the affinity engine of SCD 1051 to determine one or more entities associated with the one or more selection criteria. At 5025, the one or more selection criteria may be received. For example, SCD 1050 may receive the one or more selection criteria from CD 1030. At 5030, one or more entities associated with the one or more selection criteria may be determined. In some embodiments, one or more entities determined as one or more recommendations of an affinity engine may include one or more persons, places, and events at places.

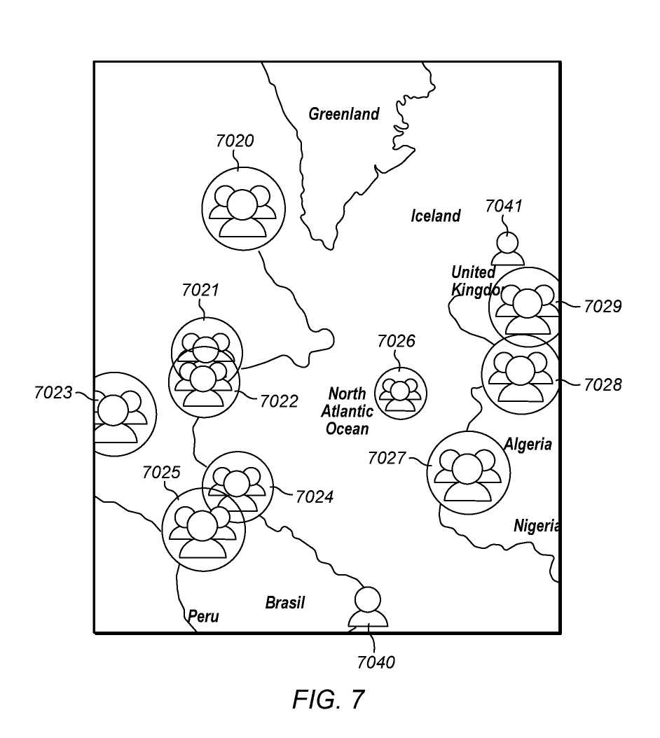

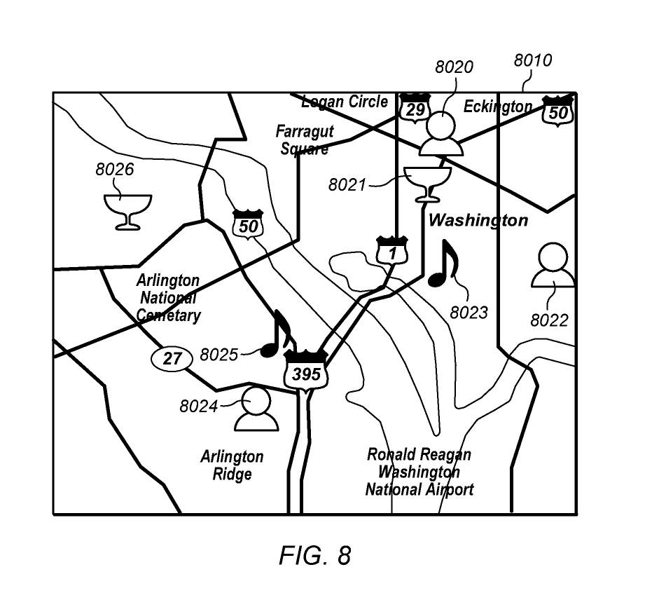

At 5035, one or more locations of the one or more entities associated with the one or more selection criteria may be determined. In some embodiments, a database may store current and/or last known locations of one or more entities. In some embodiments, the database may be searched to determine current and/or last known locations of the one or more entities associated with the one or more selection criteria. At 5040, information associated with the one or more entities associated with the one or more selection criteria may be sent to the computing device (e.g., CD 1030). In some embodiments, the information may include a map that may display one or more locations of the one or more entities associated with the one or more selection criteria. In some embodiments, the information may include location information that is usable to display a map to indicate one or more locations of the one or more entities associated with the one or more selection criteria. At 5045, information associated with the one or more entities associated with the one or more selection criteria may be displayed on a map. For example, in some embodiments, a map may be displayed to a user of CD 1030 (see FIG. 7).

FIG. 6 is an exemplary menu in accordance with one or more embodiments. In some embodiments, a menu 6010 may include one or more menu elements, such as one or more check boxes 6015-6025, selection list boxes 6030 and 6035, an abort button 6040, and a confirmation and/or proceed button 6045. In some embodiments, menu elements 6015-6035 may be used to select one or more selection criteria. For example, a user of CD 1030 may use menu elements 6015-6035 to select one or more selection criteria to search for one or more users associated with the one or more selection criteria. In some embodiments, check box 6015 may be used to indicate whether or not to include a criterion that takes into account a musical taste of a user. In some embodiments, a musical taste and/or preference of the user may be determined by an affinity engine.

In some embodiments, check boxes 6020 and 6025 may be used to include or exclude male and female users, respectively, and selection list boxes 6030 and 6035 may be used to respectively select a minimum age and a maximum age. Abort or “Cancel” button 6040 may be used to abort or cancel a search. Confirmation/proceed or “OK” button 6045 may be used to select one or more selection criteria and/or proceed with a search based on the one or more selection criteria.

FIG. 7 is an exemplary map indicating one or more entities and one or more groups of entities in accordance with one or more embodiments. In some embodiments, a map 7010 may indicate one or more locations of one or more entities. In some embodiments, map 7010 may be displayed by CD 1030. In some embodiments, map 7010 may indicate locations of multiple groups 7020-7029 of users, places, and/or events at places and/or individual users 7040 and 7041. In some embodiments, multiple users, places, and/or events at places may be indicated by a group (e.g., one of groups 7020-7029) based on a resolution of a map displaying the users.

FIG. 8 is an exemplary map indicating one or more entities in accordance with one or more embodiments. In some embodiments, a map 8010 may indicate one or more locations of one or more entities. For example, map 8010 may indicate locations of one or more individual users 8020, 8022, and 8024, one or more places 8021 and 8026, and one or more entities 8023 and 8025 that have recently had a same or a similar experience and/or have recently performed a same or a similar function (e.g., played a same song, viewed a same video, browsed a same or similar web site, etc.) as a current user of CD 1030.

In some embodiments, users 8020, 8022, and 8024 can be included in user group 7022 (see FIG. 7). User group 7022 may be selected via user input. In some embodiments, map 8010 may indicate users 8020, 8022, and 8024 based on a resolution of map 8010. Map 8010 may be displayed by CD 1030 indicating one or more locations of one or more users 8020, 8022, and 8024.

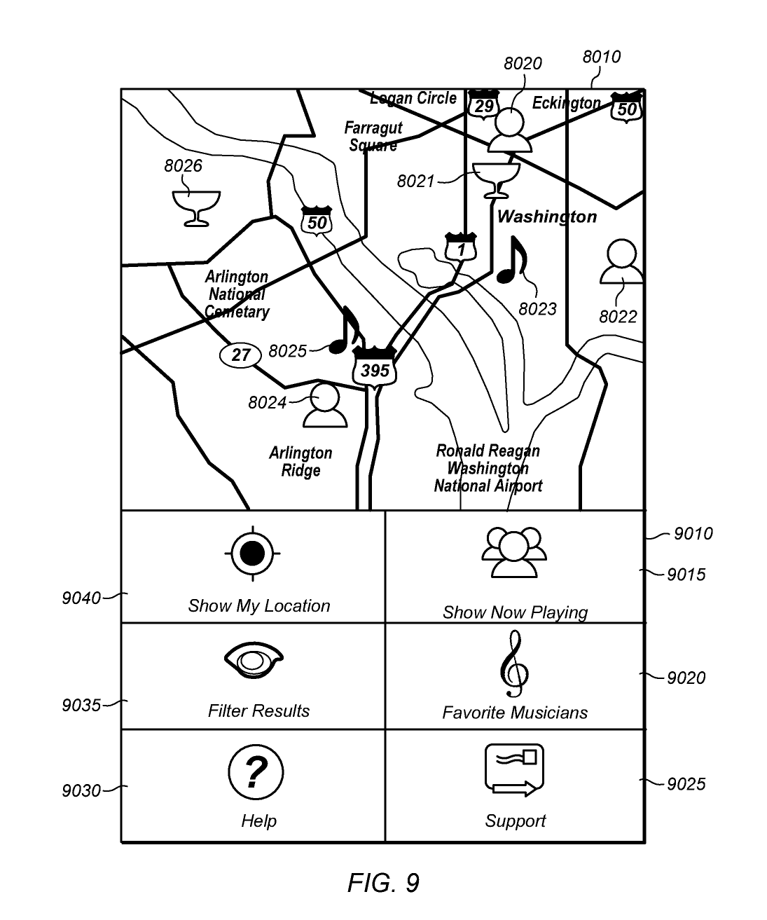

FIG. 9 is an exemplary map and an exemplary menu in accordance with one or more embodiments. In some embodiments, map 8010 may indicate locations of one or more entities 8020-8026 as described above with reference to FIG. 8. In some embodiments, a menu 9010 may include menu elements 9015-9040. Menu 9010 may be displayed by CD 1030. In some embodiments, one or more of menu items 9015, 9020, and 9035 may be used as a selection criterion and/or may be used to input one or more selection criteria. In one example, menu item 9015 may be used as a selection criterion to show entities currently playing a song currently being played by CD 1030. In a second example, menu item 9035 may be used to access menu 6010 (see FIG. 6), where one or more selection criteria may be input. In another example, menu item 9020 may be used to input one or more favorite musicians.

Menu item 9040 may be selected to add a current location of the computing device (e.g., CD 1030) used by a user. Menu items 9025 and 9030 may be selected to provide support to the user. For example, menu item 9030 may be selected, and information may be retrieved (e.g., from a local memory, from a network, etc.) and displayed to the user. In another example, menu item 9025 may be selected, and someone from a support staff (e.g., an operator) may be contacted to provide assistance to the user.

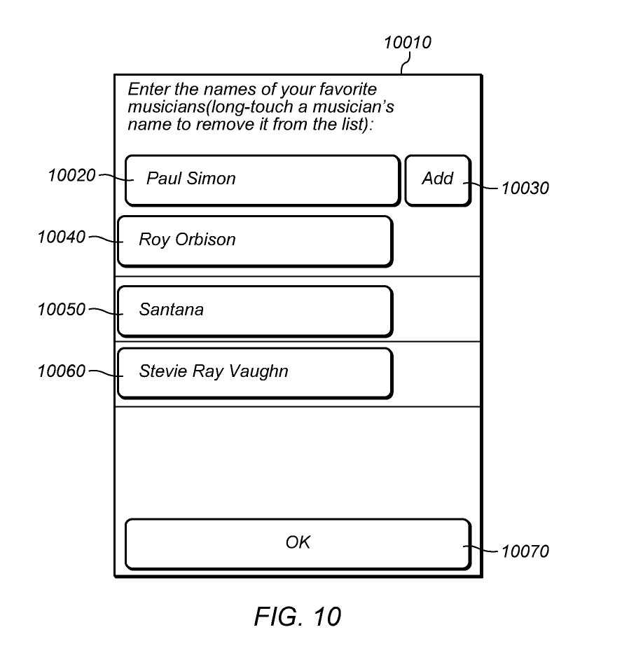

FIG. 10 is an exemplary input menu in accordance with one or more embodiments. Menu 10010 may be displayed by CD 1030. In some embodiments, a menu 10010 may be used to input a favorite musician. For example, “Paul Simon” may be input into an input area 10020, and add or confirmation menu element 10030 may be selected to add “Paul Simon” to a list of favorite musicians and/or music groups. In some embodiments, list elements 1040-1060 may indicate favorite musicians and/or music groups. For example, list elements 1040-1060 may include “Roy Orbison”, “Santana”, and “Stevie Ray Vaughan”, respectively. Menu item 10070 may be selected when one or more modifications to the list of favorite musicians and/or music groups have been completed.

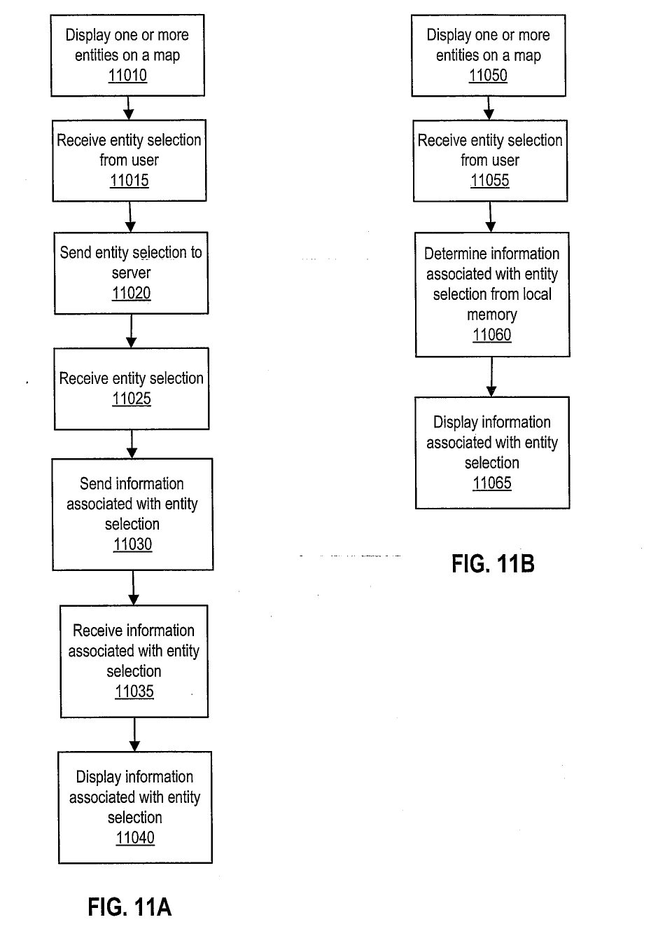

FIG. 11A is a flow chart illustrating a method for exploring an entity associated with one or more selection criteria in accordance with one or more embodiments. At 11010, a map indicating locations of entities may be displayed. For example, CD 1030 may display entities associated with the one or more selection criteria. In some embodiments, CD 1030 may display map 8010 indicating locations of entities 8020-8025. At 11015, an entity selection may be received. For example, a user may select entity 8024 and CD 1030 may receive the selection of entity 8024. At 11020, the entity selection may be sent to a server. For example, CD 1030 may send the entity selection to SCD 1050. In some embodiments, CD 1030 may send an identification associated with entity 8024 usable by SCD 1050 to identify entity 8024. At 11025, information associated with the entity selection may be received. For example, SCD 1050 may receive the information associated with the entity selection. In some embodiments, SCD 1050 may receive the identification associated with entity 8024 from CD 1030. At 11030, information associated with the entity selection may be sent. For example, SCD 1050 may send information associated with the entity selection to CD 1030. At 11035, the information associated with the entity selection may be received. For example, CD 1030 may receive the information associated with the entity selection. At 11040, the information associated with the entity selection may be displayed. For example, CD 1030 may display the information associated with the entity selection.

FIG. 11B is a flow chart illustrated a method for exploring an entity associated with one or more selection criteria in accordance with one or more embodiments. At 11050, a map indicating locations of entities may be displayed. For example, CD 1030 may display entities associated with the one or more selection criteria. In some embodiments, CD 1030 may display map 8010 indicating locations of entities 8020-8025. At 11055, an entity selection may be received. For example, a user may select entity 8024 and CD 1030 may receive the selection of entity 8024. At 11060, information associated with the entity selection may be determined from a local memory. For example, CD 1030 may store information associated with one or more entities in a memory of CD 1030 and the memory of CD 1030 may be searched to determine information associated with the entity selection. In some embodiments, the memory of CD 1030 may be updated, at one or more times, with information associated with one or more entities. At 11065, the information associated with the entity selection may be displayed. For example, CD 1030 may display the information associated with the entity selection.

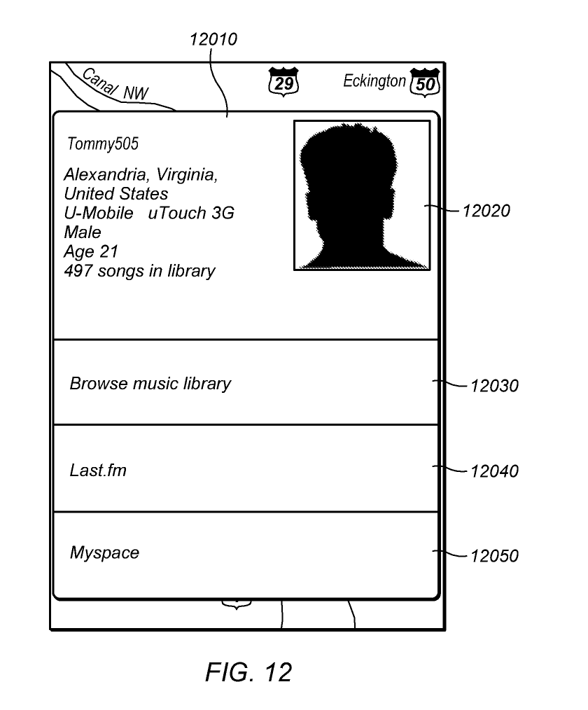

FIG. 12 is an exemplary diagram of information associated with an entity selection in accordance with one or more embodiments. In some embodiments, a user may select a marker representing an entity. The user may then be presented with a description of that entity and a menu of operations that may be performed with the information associated with the entity selection. In some embodiments, information 12010 may include a description. For example, a description of entity 8024 may be displayed. In some embodiments, the description may include one or more of an online name (e.g., “Tommy505”), a location (e.g., “Alexandria, Va., United States”), a service provider (e.g., “U-Mobile”), a service of the service provider (e.g., “uTouch 3G”), a gender (e.g., “Male”), an age (e.g., “21”), and a number of songs in a library of entity 8024, etc. In some embodiments, information 12010 may include a picture 12020 of the selected entity.

In some embodiments, a menu of operations that may be performed with the information associated with the entity selection may be displayed. In some embodiments, a menu item 12030 may be selected to browse a music library of the entity selection. In some embodiments, menu items 12040 and 12050 may be selected to browse one or more online social network website pages of the entity selection. For example, menu item 12040 may be selected to browse a music online social network website page of the entity selection. The music online social network website page of the entity selection may include one or more online radio stations used by the entity selection. In another example, menu item 12050 may be selected to browse a music social network website page of the entity selection. The online social network website page of the entity selection may include a page from MySpace, Facebook, etc.

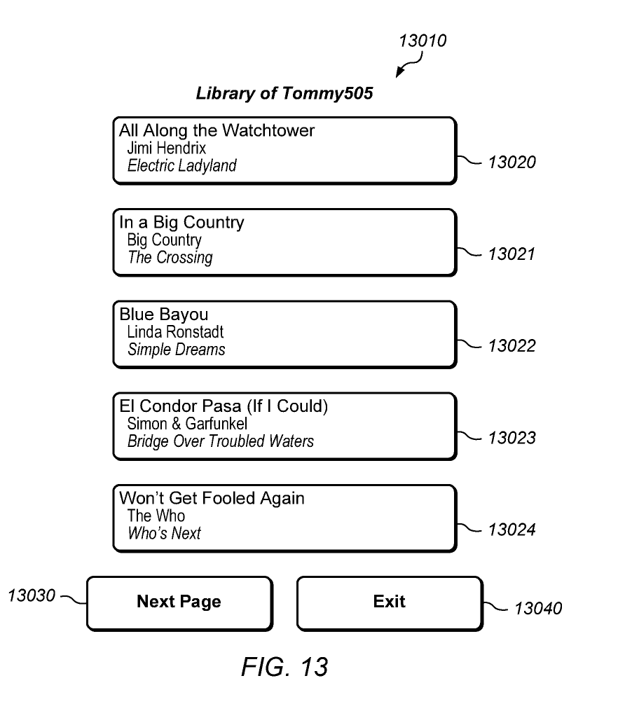

FIG. 13 is an exemplary library of an entity in accordance with one or more embodiments. In some embodiments, a library 13010 of an entity (e.g., entity 3020) may include one or more library elements 13020-13024, and library 13010 may be displayed by CD 1030, for example. In some embodiments, one or more of library elements 13020-13024 may indicate information associated with music and/or video. For example, library element 13020 may be associated with a song such as “All Along the Watchtower” performed by Jimi Hendrix from the album Electric Ladyland. In another example, library element 13021 may be associated with a music video such as “In a Big Country” performed by Big Country from the album The Crossing.

In some embodiments, library element 13022 may be associated with a song such as “Blue Bayou” performed by Linda Rohnstadt from the album Simple Dreams. In some embodiments, an affinity engine may have recommended entity 8024 to a user of CD 1030 since “Blue Bayou” was written by Roy Orbison and Joe Melson, where Roy Orbison is included in a favorite musician list of the user of CD 1030. In some embodiments, library element 13023 may be associated with a song such as “El Condor Pasa (If I Could)” performed by Simon & Garfunkel from the album Bridge Over Troubled Waters. In some embodiments, an affinity engine may have recommended entity 8024 to a user of CD 1030 since “El Condor Pasa (If I Could)” was performed by Simon & Garfunkel which included Paul Simon, who is included in a favorite musician list of the user of MCD 1030.

In some embodiments, a menu control or library control element 13030 may be selected to proceed to another page of library 13010. In some embodiments, a menu control or library control element 13040 may be selected to exit library 13010.

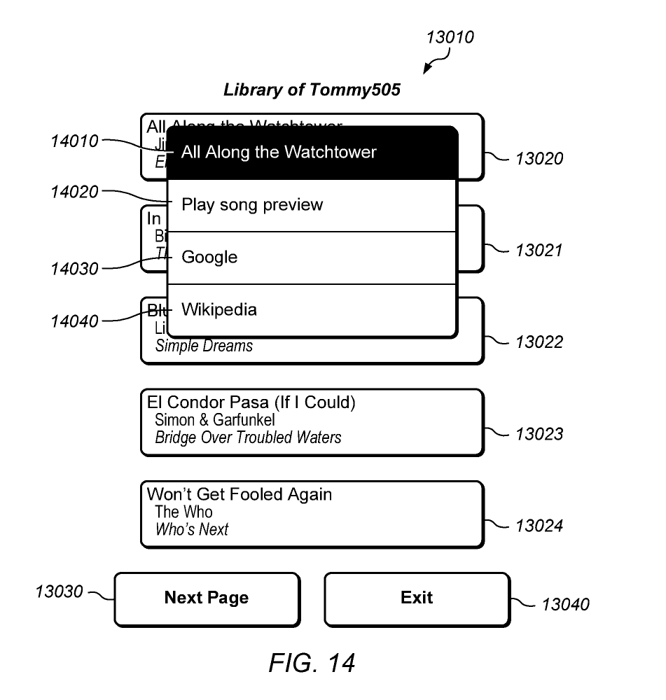

FIG. 14 is an exemplary menu associated with a library element in accordance with one or more embodiments. In some embodiments, a menu 14010 may be associated with library element 13020 and may include menu elements 14020-14040. In some embodiments, menu item 14020 may be selected to play a preview of the song (and/or video if available) associated with library element 13020 (e.g., “All Along the Watchtower”). Menu item 14030 may be selected to search for the song associated with library element 13020 in a search engine (e.g., Google, Bing, Yahoo!, etc.) and menu item 14040 may be selected to search for information of the song associated with library element 13020 in an online database (e.g., Wikipedia).

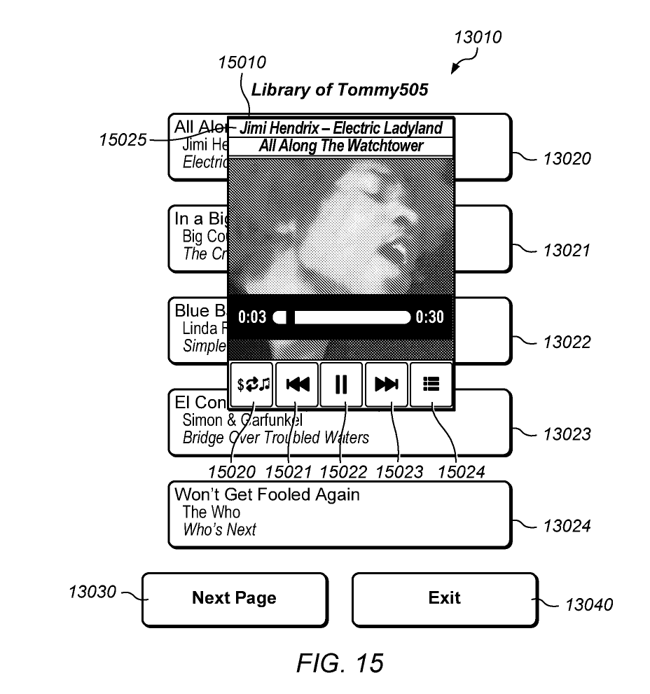

FIG. 15 is an exemplary media player interface in accordance with one or more embodiments. In some embodiments, a media player interface 15010 may include interface controls 15020-15024. Media player interface 15010 may be displayed by CD 1030. In some embodiments, interface control 15020 may be selected to purchase a complete version of the current media playing (e.g., purchased from an online retailer such as iTunes, Amazon.com, etc.). Interface element 15021 may be selected to direct the media player interface to go to a beginning of the current preview or to go to a previous preview. Interface element 15022 may be selected to pause or start the current preview. Interface element 15023 may be selected to go to an end of the current media playing or to go to a next media. Interface element 15024 may be selected to view a menu of library items that may be played or previewed. Interface element 15025 may be selected to view one or more of song information, video information, artist information, photos, discography information, liner notes, and lyrics, etc.

In some embodiments, the menu of library items that may be played or previewed may include all or some, but not all, of the media in library 13010. For example, one or more media in library 13010 may not be available to be played or previewed. In some embodiments, one or more media in library 13010 may not be available to be played or previewed in an online format. In some embodiments, one or more media of library 13010 may be played in entirety. In some embodiments, one or more media of library 13010 may be played in an abridged form, such as a preview.

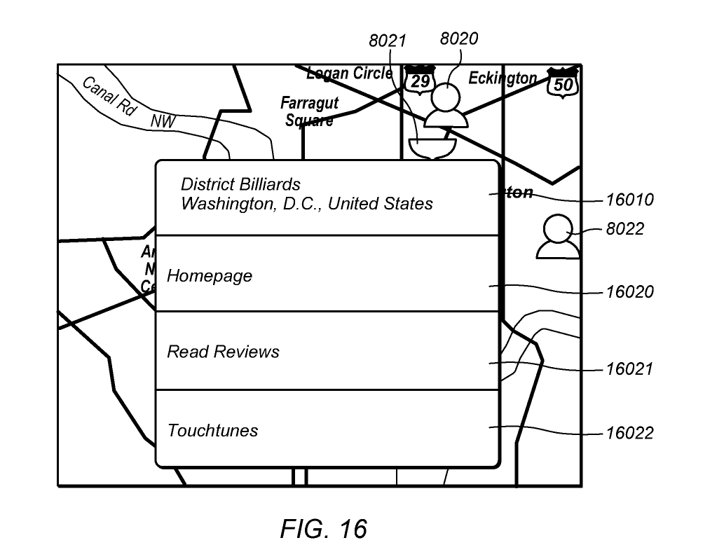

FIG. 16 is an exemplary diagram of information associated with an entity selection in accordance with one or more embodiments. In some embodiments, a user may select a marker representing an entity (e.g., entities 8020-8022). The user may then be presented with a description of that entity and a menu of operations that may be performed with the information associated with the entity selection. In some embodiments, information 16010 associated with entity 8021 (e.g., a bar, a pool hall, a dance hall, an entertainment venue, etc.) may include a description. For example, a description 16010 of entity 8021 may be displayed. In some embodiments, description 16010 may include one or more of an establishment name (e.g., “District Billiards”) and a location (e.g., “Washington, D.C., United States”), etc.

In some embodiments, a menu of operations that may be performed with the information associated with the entity selection may be displayed. In some embodiments, a menu item 16020 may be selected to browse a homepage (e.g., a web page) of the entity selection. A menu item 16021 may be selected to browse one or more online reviews of the entity selection. A menu item 16022 may be selected to view songs and/or views that are playing or have been recently played by a computing device (e.g., CD 1038) of place or entity 8021. For example, CD 1038 may include a jukebox, and Touchtunes may provide a service that includes a database that tracks music and/or videos played on the jukebox. For instance, the Touchtunes service may provide a web page for each place that has a jukebox included in a computing device (e.g., one of CD 1030-1039).

In some embodiments, the text of the establishment name may be selected, and turn-by-turn directions to entity 8021 may be provided. In some embodiments, menu item 16020 may be selected to provide one or more of a promotion (e.g., a coupon, a discount, a “buy one get one free deal”, etc.) of entity 8021, a menu of food and/or drinks available at entity 8021, and/or one or more activities (e.g., billiards, pocket billiards, dominos, shuffleboard, miniature golf, video games, etc.) available at entity 8021, etc.

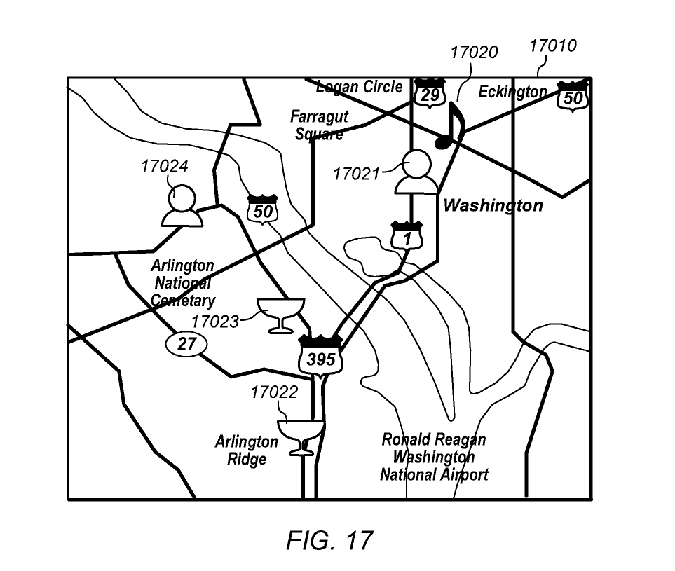

FIG. 17 is an exemplary map indicating one or more entities in accordance with one or more embodiments. In some embodiments, a map 17010 may indicate one or more locations of one or more entities recently having a same or a similar experience or having performed a same or a similar function (e.g., playing a same song, viewing a same video, browsing a same web site, etc.) as a current user of CD 1030. In one example, map 17010 indicates locations of entities 17020-17024 where at least one entity that has recently played a same song that CD 1030 is currently playing. In some embodiments, map 17010 may indicate locations of one or more individual users 17021 and 17024 and one or more places 17022 and 17023, and user 17020 who has recently played a same song that CD 1030 is currently playing. Map 17010 may be displayed by CD 1030. In some embodiments, menu item 9015 may be selected to produce map 17010.

In some embodiments, when CD 1030 changes a current song being played, map 17010 may be updated so that entities may be removed from map 17010 and/or possible other entities may be added to map 17010 to indicate one or more entities that have recently played a same song that CD 1030 is currently playing (i.e., the changed current song). In some embodiments, one or more of CDs 1030-1039 may transmit information about what songs and/or videos have been played to a server (e.g., SCD 1050). For example, the information about what songs and/or videos have been played may be stored in a database. In some embodiments, CD 1030 may query SCD 1050 to receive map 17010 or to receive information to produce map 17010.

In some embodiments, one or more systems and/or methods described herein may be applied to generating recommendations of various other entities based on selection criteria. For example, one or more systems and/or methods described herein may be applied to determining recommendations of one or more of restaurants, movies, plays, books, electric books, audio books, and dance clubs, etc., based on similarities of a user profile and/or one or more selection criteria of a user of a computing device.

One or more modifications and/or alternative embodiments of one or more aspects of the disclosure may be apparent to those skilled in the art in view of this description. Thus, this description is to be understood as illustrative only and is for the purpose of teaching those skilled in the art the general manner of carrying out the embodiments described herein. In one example, one or more of CDs 1301-1039 may include one or more same or similar structures and/or functionalities of CD 1030 and may be used in place of CD 1030 in the description. In a second example, one or more of SCDs 1051 and 1052 may include one or more same or similar structures and/or functionalities of SCD 1050 and may be used in place of SCD 1050 in the description.

In some embodiments, one or more of the method elements described herein and/or one or more portions of an implementation of a method element may be performed in varying orders, may be performed concurrently with one or more of the other method elements and/or one or more portions of an implementation of a method element, or may be omitted. Additional method elements may be performed as desired. In some embodiments, concurrently may mean simultaneously. In some embodiments, concurrently may mean apparently simultaneously according to some metric. For example, two or more method elements and/or two or more portions of an implementation of a method element may be performed such that they appear to be simultaneous to a human. In some embodiments, one or more of the system elements described herein may be omitted and additional system elements may be added as desired. In some embodiments, elements and materials may be substituted for those illustrated and described herein, parts and processes may be reversed, and certain features of the disclosure may be utilized independently, all as would be apparent to one skilled in the art after having the benefit of this description.

What is claimed is:

1. A method of transmitting information between two or more entities in a network, the method comprising:
a computer system in the network receiving one or more selection criteria from a first entity in the network;
the computer system determining one or more other entities in the network associated with the received selection criteria;
the computer system communicating information at least partially describing the determined entities to the first entity;
the computer system receiving an entity selection from the first entity; and
the computer system communicatively coupling the first entity to a selected entity of the determined entities such that interaction between the first entity and information regarding the selected entity is permitted.

2. The method of claim 1, wherein determining one or more other entities in the network associated with the received selection criteria comprises communicating the selection criteria to an affinity engine.

3. The method of claim 1, wherein determining one or more other entities in the network associated with the received selection criteria comprises communicating with the other entities in the network.

4. The method of claim 1, wherein determining one or more other entities in the network associated with the received selection criteria comprises searching a database, the database storing information at least partially describing one or more other entities in the network.

5. The method of claim 1, wherein information regarding the selected entity comprises a media library, and wherein interaction between the first entity and information regarding the selected entity comprises accessing one or more elements of the media library.

6. The method of claim 1, wherein the computer system is a server computer of the network.

7. The method of claim 1, wherein the selection criteria comprises information regarding audio files.

8. The method of claim 7, wherein the information regarding audio files comprises one or more quantifiable attributes.

9. The method of claim 1, wherein the selection criteria comprises information determined by an affinity engine.

10. The method of claim 1, wherein the selection criteria comprises criteria that have been met within a specified time period.

11. The method of claim 1, wherein the selection criteria comprises criteria that are currently being met.

12. The method of claim 1, wherein the information at least partially describing the determined entities comprises an identity of the respective determined entities.

13. The method of claim 1, wherein a determined entity comprises an entity other than the first entity matching one or more of the selection criteria.

14. The method of claim 1, wherein a determined entity comprises an entity other than the first entity matching a majority of the selection criteria.

15. The method of claim 1, wherein the information at least partially describing the determined entities comprises a physical location of the determined entities.

16. A computer system, comprising:
a processor;
a memory coupled to the processor and configured to store program instructions executable by the processor to:
receive one or more selection criteria from a first entity in the network;
determine one or more other entities in the network associated with the received selection criteria;
communicate information at least partially describing the determined entities to the first entity;
receive an entity selection from the first entity; and
communicatively couple the first entity to a selected entity of the determined entities such that interaction between the first entity and information regarding the selected entity is permitted during use.

17. A tangible, computer readable physical storage medium comprising program instructions stored thereon, wherein the program instructions are computer-executable to:
receive one or more selection criteria from a first entity in the network;
determine one or more other entities in the network associated with the received selection criteria;
communicate information at least partially describing the determined entities to the first entity;
receive an entity selection from the first entity; and
communicatively couple the first entity to a selected entity of the determined entities such that interaction between the first entity and information regarding the selected entity is permitted during use.
